(19) United States
(12) Patent Application Publication
(10) Pub. No.: US 2010/0057911 A1
(43) Pub. Date: Mar. 4, 2010

(54) Enhanced User Control Over Processing Parameters

(75) Inventors: Joel Soppet, Pleasanton, CA (US); Charles Soppet, San Diego, CA (US)

Correspondence Address: FISH & ASSOCIATES, PC;ROBERT D. FISH, 2603 Main Street, Suite 1000, Irvine, CA, 92614-6232, US

(73) Assignee: C&C GROUP, INC., Reno, NV (US)

(21) Appl. No.: 12/199,431

(22) Filed: Aug. 27, 2008

(51) Int. Cl. G06F 21/00; G06F 15/16

(52) U.S. Cl. 709/226; 726/27

(57) ABSTRACT

A distributed application infrastructure to run business logic routines on data stored on different computer systems has a security module that limits where data can be transferred to within a single application that spans multiple computer systems. The data can be designated as private, which means that the data is never transferred from its home computer system, or as public, which means that the data could be transferred to any other computer system running the distributed application, or as protected, which means that the data could only be transferred to pre-designated computer systems running the distributed application.

### FIELD OF THE INVENTION

The field of the invention is distributed application infrastructures.

### BACKGROUND

It is known in the art to create distributed applications across multiple computers to increase performance or distribute load. For example, a distributed infrastructure called Berkeley Open Infrastructure for Network Computing (BOINC) allows multiple computers to work together to process data very rapidly. Another example is SETI@home, which is an instance of BOINC that allows millions of computers connected to the internet to analyze chunks of radio transmissions about as fast as the world's fastest supercomputers. The information sent using the BOINC infrastructure, however, is not protected, so any of the computers running the program can “sniff” information travelling to and from one or more of the other computers.

US 2006/165040 to Rathod teaches a distributed computing system that builds a secure framework of computers that are “trusted,” but prevents other computers that are “not trusted” from accessing the framework. This, however, limits the number of computers that might otherwise be involved in the distributed computing system. None of the computers in the “not trusted” group can be used in the distributed computing system. Rathod and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply. Unless a contrary intent is apparent from the context, all ranges recited herein are inclusive of their endpoints, and open-ended ranges should be interpreted to include only commercially practical values.

WO 2008/057970 to Dillaway teaches a distributed computing system that allows multiple computers in a single computing system to securely work together by verifying that each incoming message is securely digitally signed, and by then digitally signing each outgoing message to ensure that all computers acting within the network grid are trusted to prevent any private information from leaking. However, digital signatures can be cracked and/or mimicked, especially if a distributed computer is not secure, for example if a hacker has physical access to the distributed computer or if the firewall on the distributed computer is not secure. If the security of a distributed computer is compromised, the only alternative is to discontinue connecting to that distributed computer, which reduces the resources that can be allocated to the process.

The magazine article Ericka Chickowski, “Google Apps Set Off Security Alarms” WWW.BASELINEMAG.COM July 2008, pg. 28-31, accessed Aug. 14, 2008, comments on how internet web applications allow companies to upload data to centers so that information can be worked upon on multiple computers, but that storing data in remote data warehouses worry IT security experts. Thus, even with a IT infrastructure that is completely secure, customers are still wary that when information leaves their computer for any reason, that information may never be 100% secure. Thus, there is a need in the art for systems and methods to better protect private information from being accessed when distributing application load across multiple computers.

### SUMMARY OF THE INVENTION

The present invention provides apparatus, systems and methods in which a distributed application secures data.

Data processed by the distributed application could be divided into distinct chunks that are distributed between computers in the grid. In the present invention, the data is categorized into “private data,” “protected data,” and “public data.” Security policies regulate the data to restrict its movement between the networked computers. Private data is restricted from being transferred between computers, public data is not restricted from being transferred between computers, and protected data is restricted to two or more computers in the network. There can be multiple levels of protected data, for example one level of protected data that can be transferred only between computers A, B, and C, and another level of protected data that can be transferred only between computers C, D, and E.

The designation of what data is “private,” “protected,” and “public,” can be determined in any suitable manner. For example, a company could have a security policy of keeping certain information confidential, an individual could determine that data from certain sources is more likely to have viruses and shouldn't be transferred. Exemplary “private data” includes medical information, account passwords, and family life, while exemplary “public data” includes public stock records, news articles, and archived science journals.

While a computer's degree of scope is generally determined by the degree of scope of data saved on the computer's memory, a company or a personal policy could determine which computers are assigned to different levels of “protected” data, for example by designating all computers in a company's intranet to be “protected” and all other computers to be “unprotected.” In this manner, if a previously “protected” computer was compromised, the computer could be designated as “unprotected” and could still assist in distributed application processes.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a single computer system with private data, protected data, and public data.

FIG. 2 is a single computer system with private data, public data and multiple levels of protected data.

FIG. 3 is the single computer system of FIG. 2, networked with other computer systems.

FIG. 4 is an isolated single computer system housing only public data.

FIG. 5 is an isolated single computer system housing only protected data.

FIG. 6 is an isolated single computer system housing only public data.

FIG. 7 is an isolated single computer system housing a combination of private data, protected data and public data.

FIGS. 8A, 8B, and 8C show combinations of a local computer system connected to a server computer system, where the local computer system has a higher degree of scope than the server computer system.

FIGS. 9A, 9B, and 9C show combinations of a local computer system connected to a server computer system, where the local computer system has a lower degree of scope than the server computer system.

FIGS. 10A, 10B, and 10C show combinations of a local computer system connected to a server computer system, where the local computer system has the same degree of scope as the server computer system.

FIGS. 11A and 11B show combinations of three or more computer systems networked with one another.

FIG. 12 show three or more computer systems networked with one another via the Internet.

FIG. 13 show two independently networked groups of computer systems, where the networks aren't connected to one another.

### DETAILED DESCRIPTION

Since the inventive subject matter encompasses multiple new concepts, the words used herein are defined below for the convenience of a reader who is skilled in the art.

As defined herein, a “physical computer system” is any physical device or group of physical devices with a memory and a processor that is capable of processing information to produce a desired result. The computer system has at least one physical or virtual interface where information can be input and output to and from the system to users or other computer systems.

As defined herein, a “virtual computer system” is any runtime environment that mimics a “physical computer system” in function but is not a physically separable device or group of devices with a physical memory and a physical processor, but is rather logical partition of an existing physical computer system. Such virtual computer systems are typically software implementations of a physical computer system that executes programs just like a physical computer system. Contemplated virtual computer systems include, for example, system virtual machines and process virtual machines. VMware™, for example, creates virtual computer systems by virtualizing a set of hardware within an operating system to mimic an entire physically distinct computer system. In contrast, multi-core processors that mimic a single CPU or device drivers that mimic other hardware devices are not virtual computer systems because they do not mimic an entire physical computer system.

As defined herein, a “computer system” is a physical computer system, or a virtual computer system that has a memory and a processor that is capable of processing information to produce a desired result.

As defined herein, a “distributed application” has two or more software modules where the modules are deployed on two or more computer systems that are connected to one another via a network. A single user interface could be used to virtualize the distributed application to make it appear as though only one computer is running a program, even though distinct business logic routines are being run cooperatively on multiple computers communicating over the network. Cooperative business logic routines do not have to be simultaneous or concurrent with one another, but are preferably running parallel to one another. This infrastructure is especially appropriate for web-based applications, where the input/output of the application is run on a client computer, and the actual application is run on a remote server or group of clustered servers. Typical distributed applications are two-tier (client-server), three-tier (client-middleware-server), and multitier, although other suitable configurations could be used without departing from the scope of the invention.

As defined herein, “data” is information that is stored on a computer system or is otherwise directly accessible by a computer system. Raw data is data that has not yet been processed by the distributed application, while processed data is data that is processed by either the distributed application, or one of the business logic routines of the distributed application. Processed data does not have to be a final result, but can be one of many intermediary results while the distributed application is running.

As defined herein, “private data” is data that is stored on a computer system where the data is designated as data that will not be transferred off of that computer system to other computer systems networked in the distributed application, even temporarily, unless an authorization certificate is applied to the private data.

As defined herein, “public data” is data that is stored on a computer system where the data is designated as data that could be transferred to any other computer system networked in the distributed application, either temporarily or permanently.

As defined herein, “protected data” is data that is stored on a computer system where the data is designated as data that could be transferred only to “friend” computer systems of the protected data, either temporarily or permanently, unless an authorization certificate is applied to the protected data. By default, the computer system that the protected data is on is considered to be a “friend” of the protected data.

As defined herein, a “subset” is a group of elements, where each element belongs to a second set. A subset does not include a null set, or every element of the set, but can include elements in between. For example, a subset of {1, 2, 3, 4} could include {2} and {1, 2, 4} but could not include { } or {3, 5}.

As used herein, a “business logic routine” or “BLR” is a computer executable algorithm of the distributed application that operates on the private, public, and/or protected data. A single distributed application could have multiple BLRs running serially or concurrently. Concurrent BLRs have at least a portion of the runtime duration overlapping with one another. Since BLR is considered to be a type of data, each BLR has its own designated private, protected, or public degree of scope, depending on the security policy of the data being operated upon. The output data produced by a BLR can have a different degree of scope from the data operated upon. For example, BLRs commonly produce public data from private data, which is then exported from the private computer system to a public computer system for further processing. BLRs could be copied from one computer system to another, and can be transferred in real-time to a computer system as needed or could be transferred at any time before execution is needed. Generally, all BLRs have a public degree of scope, and therefore each BLR adopts the degree of scope of the data each BLR operates upon.

As used herein, a “degree of scope” is the level of security assigned to data or a BLR (public, private, or protected). Typically, if a set of data, a set of BLR, or a set of data and BLR are grouped together to complete a designated calculation or task, then that entire set is assigned the most restrictive degree of scope in the group. If, for example, a public BLR and a private BLR need to work concurrently to complete a series of concurrent tasks, then the set of the two BLR could be designated as a private BLR. In contrast, if a public BLR runs an algorithm on both public data and protected data, the degree of scope of the BLR while performing that algorithm is protected. The degree of scope of data or a BLR could be assigned in a variety of ways, for example based on a corporate level of confidentiality, based on a risk of exposure to viruses, or based on an intranet firewall. Typically, the degree of scope is set and managed by a security module that resides either on an admin computer that controls the distributed application, or on a data storage system.

As used herein, a “data storage system” is a computer system where data is physically stored. A storage system could be a single computer with a single hard drive, or could be a single computer with multiple hard drives, or could even be multiple computers connected to a single storage device.

As used herein, a “BLR storage system” is a computer system where a BLR is physically stored. A BLR storage system could be combined with a data storage system, and is preferred where the storage systems are assigned the same or similar degrees of scope. However, BLR storage systems that are physically separate from data storage systems are also contemplated.

As used herein, an “executing system” is a computer system where a BLR processes data located on that computer system.

As used herein, a “dominant system” (DM system) is a computer system that manages the distributed application among the various computer systems in a single network. Normally, the computer system with the most restrictive scope is the dominant computer system, but public computer systems could also manage the distributed application.

As defined herein, a “display system” is a computer system where result information is displayed to a user or input information is obtained from a user. The display system does not need to be an executing system, or a dominant system, or have the most restrictive scope.

As used herein, a “controlled area” is one or more designated computer systems that all have the same scope of data. For example, private data has a controlled area of the computer system that houses the private data, protected data has a controlled area of the designated computer systems where the data is allowed to be transferred, and public data has a controlled area of all of the computer systems in the distributed application. Contemplated controlled areas are a single computer, several computers in a subnet, multiple computers on the Internet, and multiple computers on independent networks.

As used herein, an “authorization certificate” is a special certificate that allows data to be transferred outside a designated controlled area. Contemplated authorization certificates change the scope of data, allow a designated computing system to accept data outside its scope, or could allow several designated computing systems to accept data outside its scope. A system administrator generally needs to grant each authorization certificate individually on a case-by-case basis, but authorization certificates could be granted for a specified time or a specified number of uses, and could be distributed by an automated administrative service.

As used herein, a “scope aware storage system” is a storage system that is designed and operates by implementing the concepts articulated herein. Security logic built into the storage device associates store scope information with discrete sets or other units of data and restricts delivery of the data based on the data's scope and authorization certificates.

As used herein, a “scope aware software architecture” is a software execution environment that is designed and operates by implementing the concepts articulated herein. Security logic built into the software platform would manage software application behavior based on the application data's scope and restrict which computer systems execute the discrete BLR functionality based on the data's scope and authorization certificates.

As used herein, a “scope aware hardware architecture” is a computer system that is designed and operates by implementing the concepts articulated herein. Security logic built into the hardware devices that comprise the computer system implements logic that restricts movement of data based on the degree of scope, execution certificates, display certificates, and/or access certificates. Implementing BLR routines into hardware logic could also be used to increase the speed by which the algorithms execute.

As used herein, a “scope aware network architecture” is a network transport protocol that is designed and operates by implementing the concepts articulated herein. Security logic built into the network protocol implements logic that enforces data scope, as well as execution certificate, display certificate, and access certificate information into either the protocol level or the physical signal multiplexor level to increase both the level of security and speed at which the concepts discussed herein could be implemented.

As used herein, a “scope aware software application” is a software application that is designed and operates by implementing the concepts articulated herein. The software application has security logic that restricts movement of data based on the degree of scope and authorization certificates. Contemplated software applications include email, accounting, customer relationship management, and manufacturing.

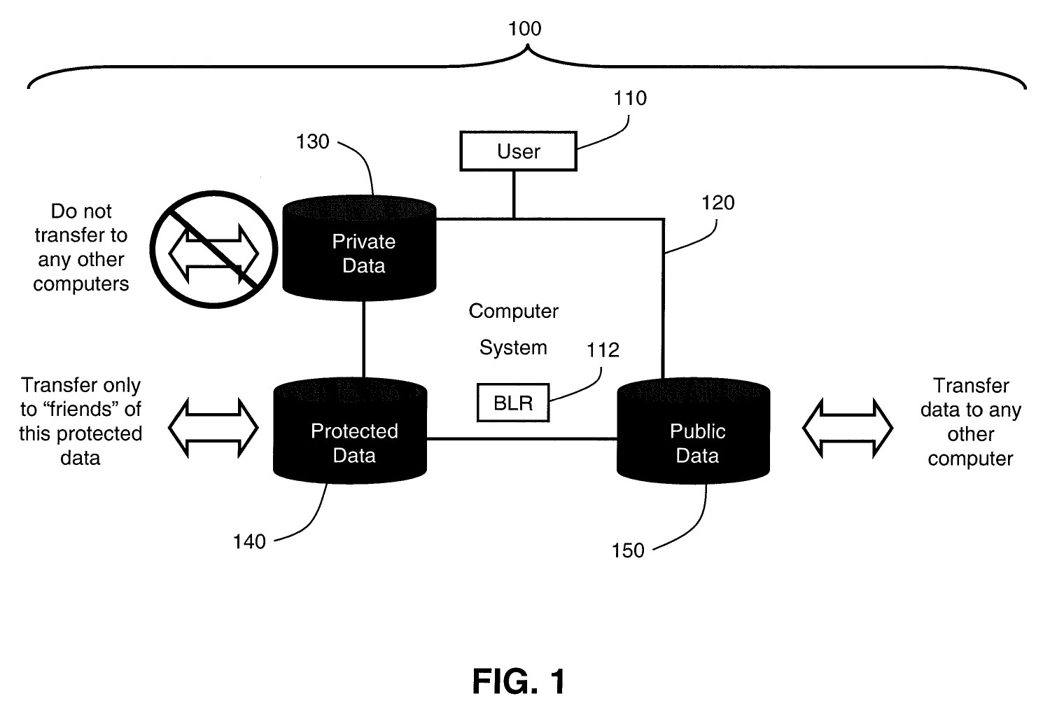

In FIG. 1, a computer system 100 generally has a computer 120 with a combination of private data 130, protected data 140, and public data 150.

Generally, a user 110 connects to computer system 120 through a user interface (not shown) that is either physical or virtual, for example a monitor and a keyboard or an internet connection, respectively. Computer system 120 is a physical or virtual computer system that has memory that holds data and that is capable of processing information on that data in order to produce a desired result. For example, computer system 120 could run a tax calculation on an excel spreadsheet of data to produce income tax data, or could run search algorithms on documents to find content. A computer system has one or more BLRs 112 that manages, transfers, and/or processes information on the data that is stored on the computer system. The BLR could be pre-installed in the computer system before execution of the distributed application, or could be downloaded into the computer system before execution of code.

Computer system 120 has data that is divided into three categories: private data 130, protected data 140, and public data 150. Private data 130 remains on computer system 120 and is not moved or copied to other computer systems. Any BLRs that processing private data 130 either needs to be first copied to computer system 120 before the BLR is executed, or needs to send computer system 120 an authorization certificate (not shown) to override the security settings on computer system 120. In contrast, protected data 140 could be moved or copied from computer system 120 to any “friends” of protected data 140, unless an authorization certificate (not shown) is sent to computer system 120 to override the security settings. Lastly, public data 150 can be moved or copied from computer system 120 for any reason.

Designation of a data's degree of scope (whether the data is private, protected, or public) can be made in any suitable manner at any time. In one embodiment, the user who creates or copies data on a computer system designates the type of data and, if the data is protected, designates what computer systems are “friends” of the protected data. In another embodiment, a security administrator determines a data's degree of scope according to a corporate policy. A security administrator bot could also be created that automatically scans data on various computer systems and redesignates the degree of scope of data due to a set of rules or an algorithm. Computer system “friends” could be designated by any suitable identifier, for example an IP address or a MAC address, or could be designated by a condition, for example whether a type of private data is located on that computer system, or whether a computer system has been running the distributed application for over six months.

In a preferred embodiment, the designation of a data's degree of scope is preformed by a security module (not shown) that assigns friends of protected data to be a few computer systems on a connected network, which restricts that data from being transferred (copied or moved) to computer systems that are not friends of that data without an authorization certificate. The user of a local computer could designate the data using the security module, but preferably a third party administrator controls the degree of scope of data.

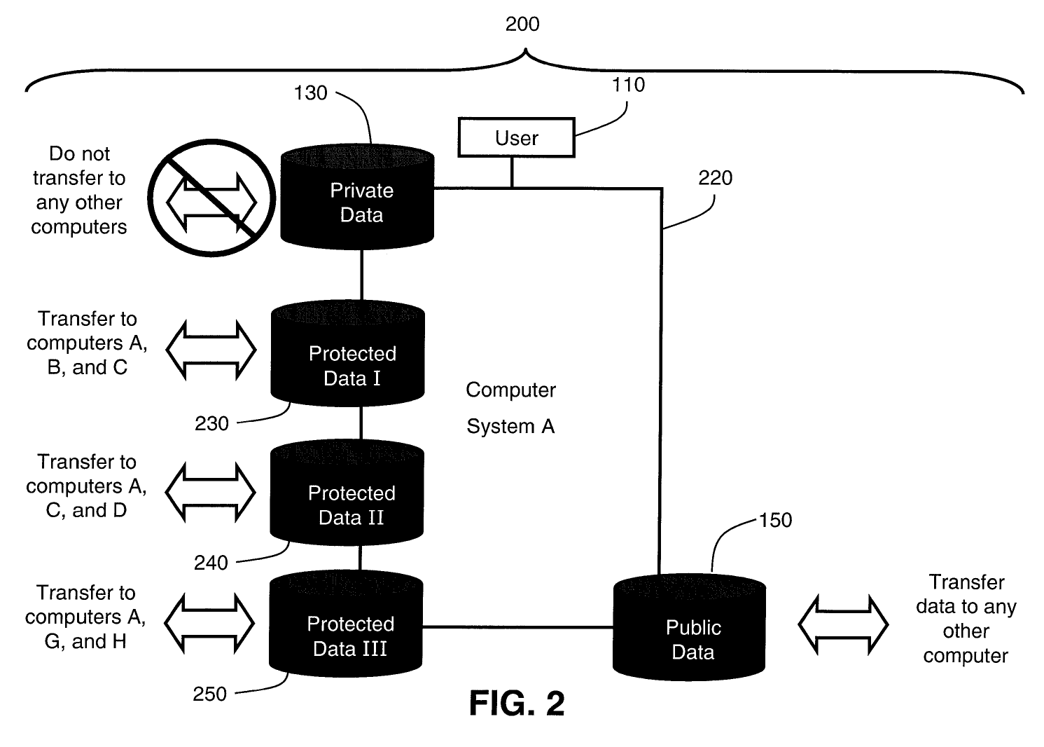

FIG. 2 shows computer system A 220 that is similar to computer system 120, but which has three different kinds of protected data, protected data I 230, protected data II 240, and protected data III 250. Protected data I 230 has “friend” computer systems A, B, and C; protected data II 240 has “friend” computer systems A, C, and D, and protected data III has “friend” computer systems A, G, and H.

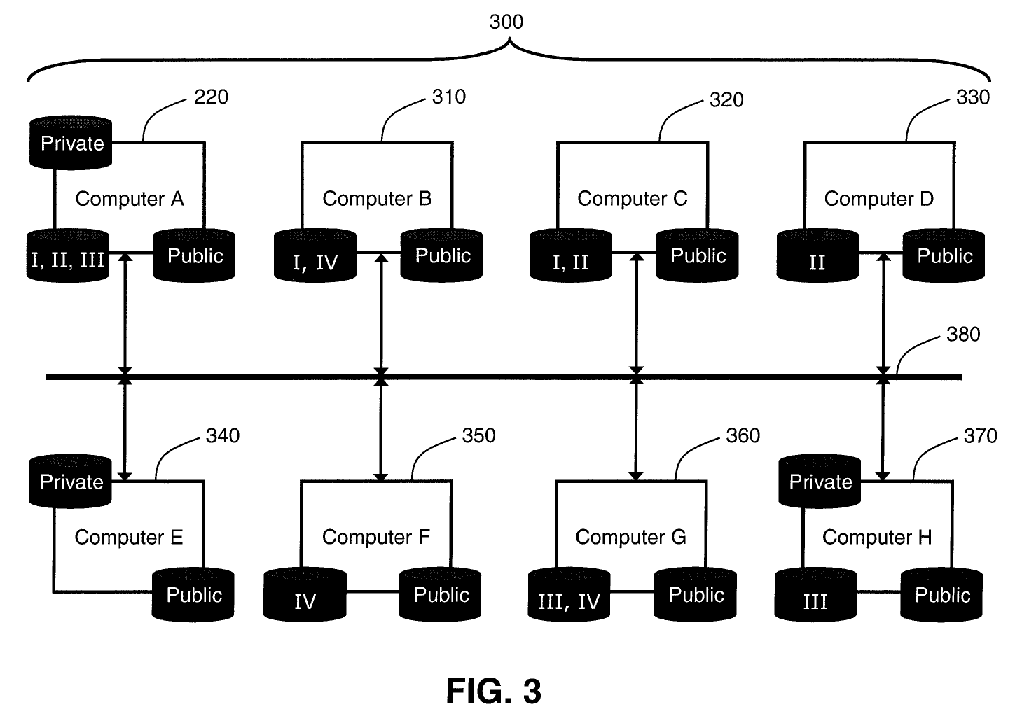

FIG. 3 shows a distributed application environment 300 where computer system A 220 is connected to computer systems B 310, C 320, D 330, E 340, F 350, G 360, and H 370 via network 380. The protected data located on computer system A 220 is copied to all “friends” of protected data I 230, II 240, and III 250 so as to distribute load among the computer systems in the distributed application environment 300. While the protected data on computer system A 220 is shown in the figure to be copied to all “friends” of the protected data, the protected data could remain on system A until a request is made for the data. Note that computer E, which is not a friend of any of the protected data, could obtain a copy of the protected data by using an authorization certificate.

In order to better illustrate the metes and bounds of the inventive subject matter, multiple examples of different computer environments are disclosed from a single computing system to multiple networks.

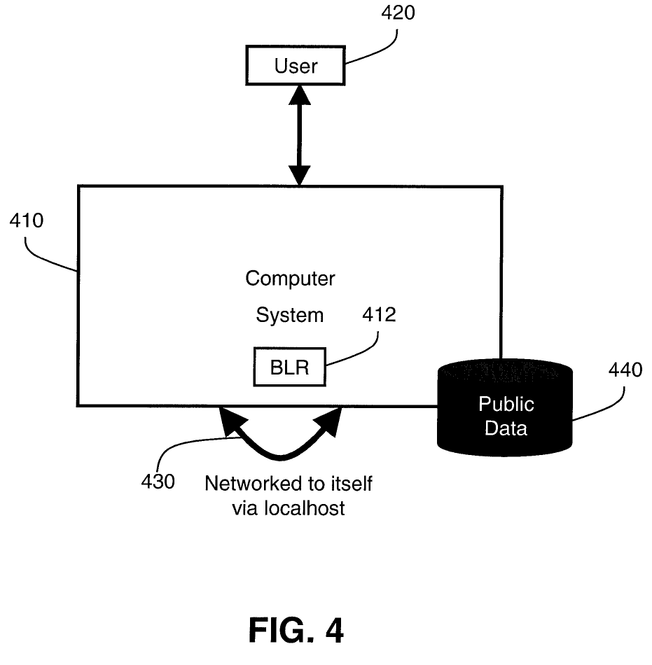

FIG. 4 shows a simple configuration of a single local computer system 410 with a user 420 accessing public data 440. The computer system 410 is not connected to a network, and instead is only connected to itself via a localhost connection 430, preferably using a localhost loopback within a network card (not shown). Computer system 410 has one or more BLRs 412 installed that work together to run a distributed application (not shown).

The only data located on computer system 410 is public data 440, which is allowed to be copied to any other computer system. When user 420 on computer system 410 desires to run BLR 412 on public data 440, the distributed application (not shown) determines that the only available system is computer system 410, verifies that both BLR 112 and public data 440 are located on computer system 410, and executes BLR 512 on public data 440, and shows the results to user 420. Alternatively, BLR 512 could be copied from computer system 410 to computer system 410, and then could run a checksum or similar operation on the copied BLR to verify that no unwanted changes were made to the code during transfer before BLR 512 is executed. Neither the public data 440, nor BLR 512 ever leaves computer system 410.

The embodiment of FIG. 4 could be used where an accountant has a desktop system that contains a new type of accounting software stored on the local hard disk. The accountant also has records for one of his clients stored on the same or secondary storage medium. The accountant decides to calculate the amount of tax owed and launches the new type of accounting application. The new type of accounting software determines that the user wants to invoke the business logic to view the public tax tables stored on the local computer system. The software checks the business logic routine's scope and determines it is operating on public data so it can be executed anywhere. Given the local computer system is the only one available, it transfers the appropriate business logic routine down to the local computer system via the network (in this case using localhost), verifies no unwanted changes were made to the code during transfer, and executes the business logic routine. The business logic reads in the data, operates on it, and produces the desired results which are displayed on the executing computer system either without traveling back across the network or after travelling back across the network (in this case via localhost). In other words, the data never travels outside of the “controlled area.”

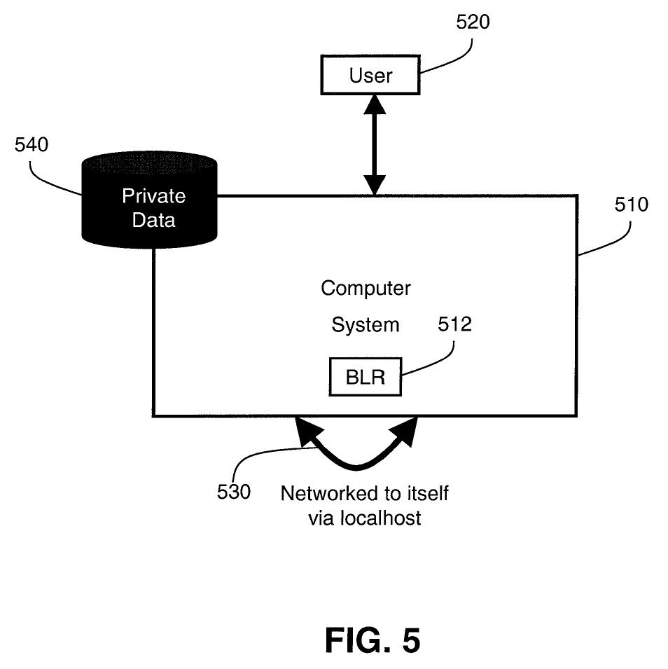

FIG. 5 shows a simple configuration of a single local computer 510 with a user 520 accessing private data 540. The computer system 510 is not connected to a network, and instead is only connected to itself via a localhost connection 530, preferably using a localhost loopback within a network card (not shown). Computer system 510 has one or more BLRs 512 installed that work together to run a distributed application (not shown).

The only data located on computer system 510 is private data 540, which can not be copied to any other computer system. When user 520 on computer system 510 desires to run BLR 512 on private data 540, the distributed application (not shown) determines that, since the data is private, BLR 512 needs to be copied to the same computer system private data 540 is located upon. The software then verifies that both BLR 512 and private data 540 are located on computer system 510, executes BLR 512 on private data 540, and shows the results to user 520. Alternatively, BLR 512 could be copied from computer system 510 to computer system 510, and could then run a checksum or similar operation on the copied BLR to verify that no unwanted changes were made to the code during transfer before BLR 512 is executed. Neither the protected data 540, nor BLR 512 ever leaves computer system 510.

The embodiment of FIG. 5 could be used where an accountant has a desktop system that contains a new type of accounting software stored on the local hard disk. The accountant also has records for one of his clients stored on the same or secondary storage medium. The accountant decides to show the person's salary and launches the new type of accounting application. The new type of accounting software determines that the user wants to invoke the business logic to show salary on data that is private to the local computer system. The software checks the business logic routine's scope and determines it is alright to transfer it down to the local computer system. It transfers the appropriate business logic routine down to the local computer system via the network (in this case using localhost), verifies that no unwanted changes were made to the code during transfer, and executes the business logic routine. The business logic reads in the data, operates on it, and produces the desired results which are displayed on the executing computer system without travelling outside the “controlled area”.

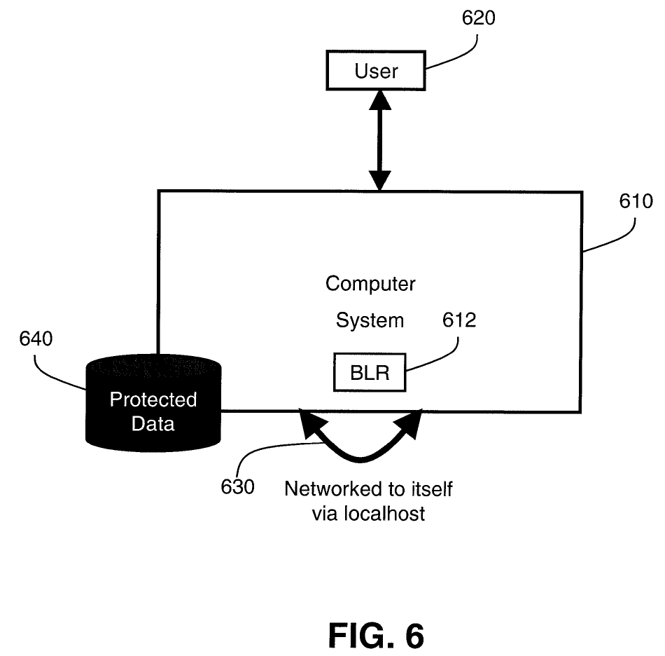

FIG. 6 shows a simple configuration of a single local computer 610 with a user 620 accessing protected data 640. The computer system 610 is not connected to a network, and instead is only connected to itself via a localhost connection 630, preferably using a localhost loopback within a network card (not shown). Computer system 610 has one or more BLRs 612 installed that work together to run a distributed application (not shown).

The only data located on computer system 610 is protected data 640, which is allowed to be copied to any “friends” of protected data 640. When user 620 on computer system 610 desires to run BLR 612 on protected data 640, the distributed application (not shown) determines that, since the data is protected, BLR 612 needs to be copied to the same computer system protected data 640 is located upon, or copy protected data 640 to a “friend” computer system with BLR 612 installed. The software then verifies that both BLR 612 and protected data 640 are located on computer system 610, executes BLR 612 on protected data 640, and shows the results to user 620. Alternatively, BLR 612 could be copied from computer system 610 to computer system 610, and then could run a checksum or similar operation on the copied BLR to verify that no unwanted changes were made to the code during transfer before BLR 612 is executed. Neither the protected data 640, nor BLR 612 ever leaves computer system 610.

The embodiment of FIG. 6 could be used where an accountant has a desktop system that contains a new type of accounting software stored on the local hard disk. The accountant also has records for one of his clients stored on the same or secondary storage medium. The accountant decides to view his client's tax bracket and launches the new type of accounting application. The new type of accounting software determines that the user wants to invoke the business logic to view the tax bracket which is protected data stored on the local computer system. This data is protected because someone could use that information along with public data to back into his client's salary range which is private data. The software checks the business logic routine's scope and determines it is alright to transfer it down to the local computer system. It transfers the appropriate business logic routine down to the local computer system via the network (in this case using localhost), verifies that no unwanted changes were made to the code during transfer, and executes the business logic routine. The business logic reads in the data, operates on it, and produces the desired results which are displayed on the executing computer system without traveling outside the “controlled area”.

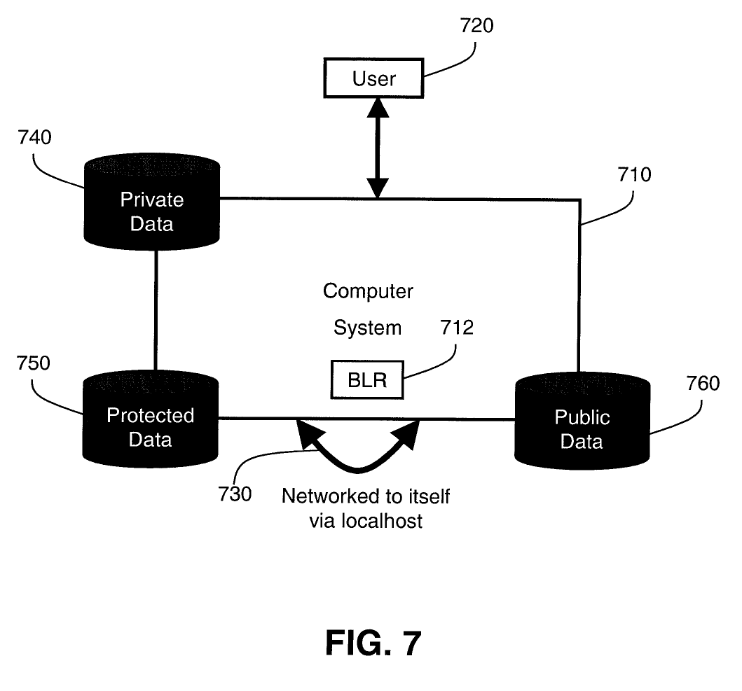

FIG. 7 shows a simple configuration of a single local computer 710 with a user 720 accessing private data 740, protected data 770, and public data 760. The computer system 710 is not connected to a network, and instead is only connected to itself via a localhost connection 730, preferably using a localhost loopback within a network card (not shown). Computer system 710 has one or more BLRs 712 installed that work together to run a distributed application (not shown).

Computer system 710 has private data 740, which is not allowed to be copied to any other computer system, protected data 750, which can only be copied to a “friend” of protected data 750, and public data 760, which is allowed to be copied to any system. When user 720 on computer system 710 desires to run BLR 712 on private data 740, protected data 750, and public data 760, the distributed application (not shown) determines that the degree of scope all the data is private, since a set of data is assigned the most restrictive degree of scope in the group. The distributed application then determines that the only available system is computer system 710, verifies that BLR 712, private data 740, protected data 750, and public data 760 are all located on computer system 710, executes BLR 712 on the set of data, and shows the results to user 720. Alternatively, BLR 712 could be copied from computer system 710 to computer system 710, and then could run a checksum or similar operation on the copied BLR to verify that no unwanted changes were made to the code during transfer before BLR 712 is executed. Private data 740, protected data 750, public data 760, and BLR 712 never leave computer system 710.

The embodiment of FIG. 7 could be used where an accountant has a desktop system that contains a new type of accounting software stored on the local hard disk. The accountant also has records for one of his clients stored on the same or secondary storage medium. The accountant decides to calculate his client's taxes based on public tax tables, private salary information, and some previous calculations which produced protected data. The accountant launches the new type of accounting application and the software determines that the user wants to invoke the business logic to perform the calculation with a private degree of scope. The software checks the business logic routine's scope and determines it is alright to transfer it down to the local computer system. It transfers the appropriate business logic routine down to the local computer system via the network (in this case using localhost), verifies that no unwanted changes were made to the code during transfer, and executes the business logic routine. The business logic reads in the data, operates on it, and produces the desired results which are displayed on the executing computer system without traveling outside the “controlled area”.

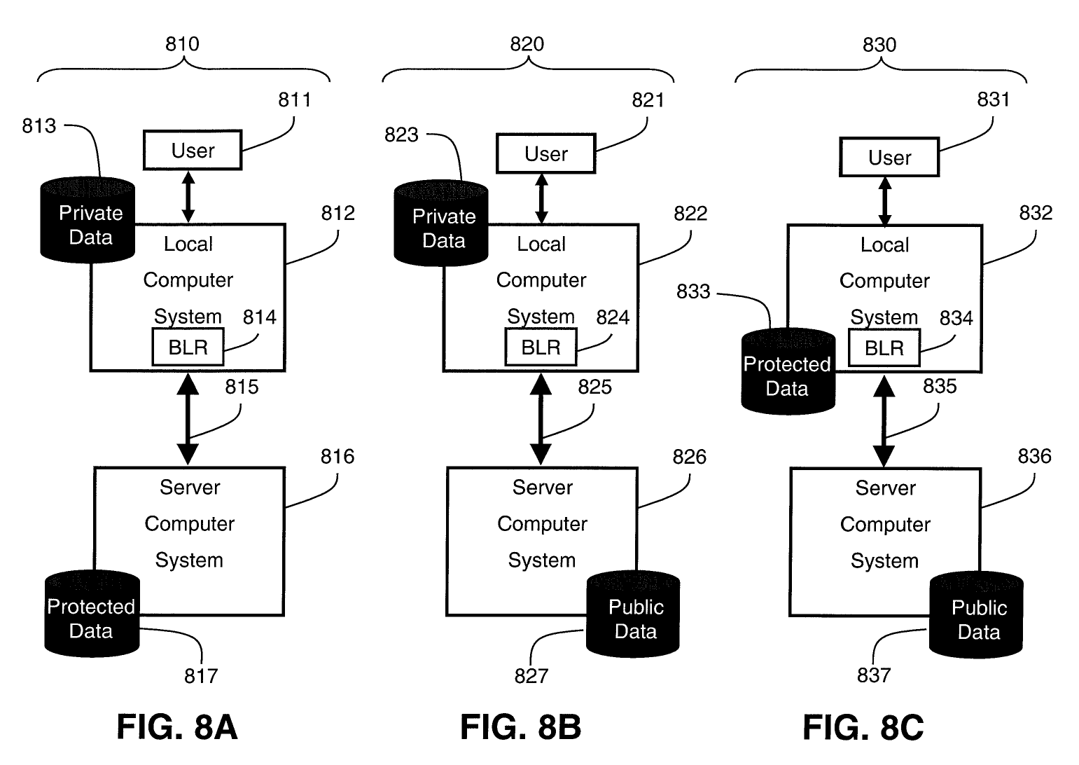

FIGS. 8A-C show different configurations 810, 820, and 830 depicted as pairs of connected computer systems with particular data configurations. In each data configuration 810, 820, and 830, the local computer system has a higher degree of scope than the server computer system.

In data configuration 810, user 811 accesses local computer system 812 with private data 813. Local computer system 812 is connected via network connection 815 to server computer system 816 with protected data 817. Note, that in configuration 810, local computer system 812 is a “friend” of protected data 816. In data configuration 820, user 821 accesses local computer system 822 with private data 823. Local computer system 822 is connected via network connection 825 to server computer system 826 with public data 827. In data configuration 830, user 831 accesses local computer system 832 with protected data 833. Local computer system 832 is connected via network connection 835 to server computer system 836 with public data 837. The network connections used in configuration 810, 820, and 830 are preferably high speed Ethernet connections, but any suitable network connection could be used without departing from the scope of the invention.

When user 811, 821, 831 on the single local computer system 812, 822, 832 desires to run BLR 814, 824, 834 on the data located on the local computer system and the server computer system, a few scenarios could occur. In a typical scenario, the distributed application could copy the data located on the server computer to the local computer, could copy the BLR to the local computer, and could execute the BLR on the two sets of data. A BLR could, however, be structured so that the BLR is copied to both the local computer system and the server computer system, and result information from the server computer system is only copied to the local computer system, but result information from the local computer system is never copied to the server computer system. In a more complex scenario, a BLR could produce result data of different scope. For example, if BLR 814 operating upon private data 813 produces both private data and public data, then BLR 814 could send public data to server computer system 815.

The configuration in configuration 810 could be used where an accountant has a desktop system that contains a new type of accounting software stored on the local hard disk. The accountant also has records for one of his clients stored on the same or secondary storage medium. The accountant decides to calculate his client's taxes based on public tax tables stored on the server and private salary information stored on the local computer system. The accountant launches the new type of accounting application and the software determines that the user wants to invoke the business logic to perform the calculation. The software determines that the BLR requires the tax table data which is on server computer system as “public data” and the salary information which is on local computer system as “private data,” which would make the local computer system the system the only computer system that could have all data and all BLRs copied to it, since it has a private scope. Next, the system checks the business logic routine's scope and determines that it is authorized to transfer it down to the local computer system. It transfers the appropriate business logic routine down to the local computer system via the network (in this case using localhost), verifies no unwanted changes were made to the code during transfer, and executes the business logic routine. The business logic reads in the data, operates on it, and produces the desired results which are displayed on the executing computer system without traveling outside the “controlled area”.

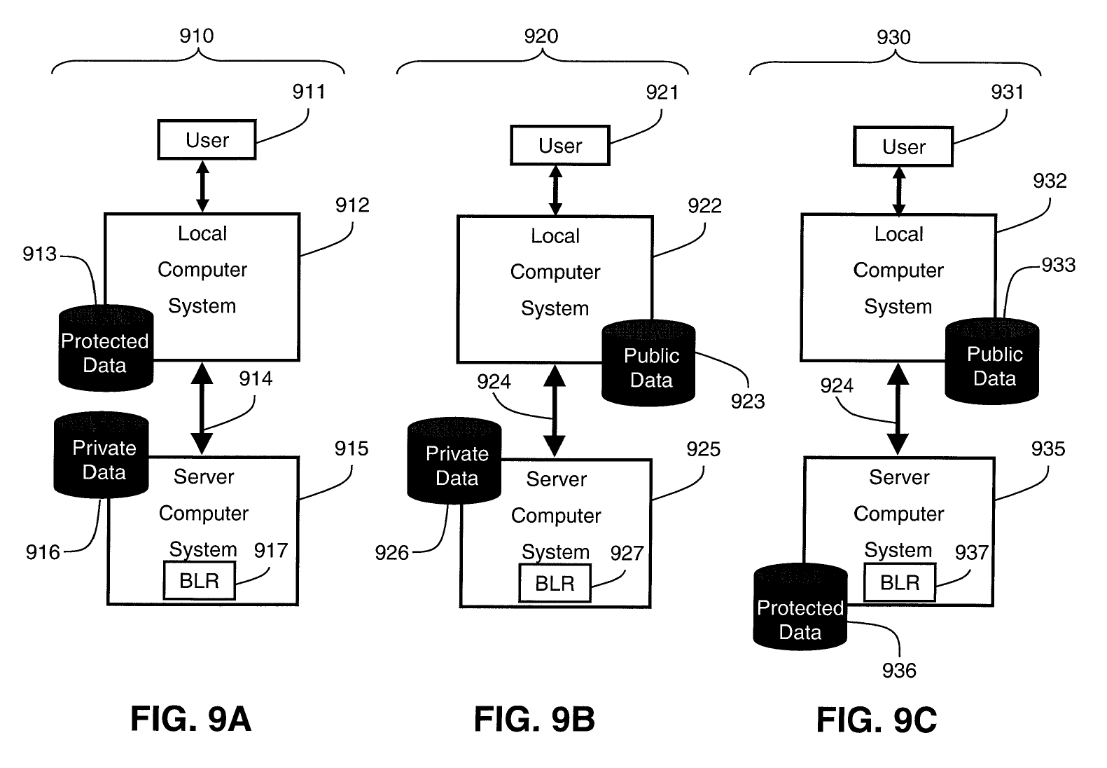

FIGS. 9A-C show different configurations 910, 920, and 930 depicted as pairs of connected computer systems with other data configurations. In each data configuration 910, 920, and 930, the server computer system has a higher degree of scope than the local computer system.

In data configuration 910, user 911 accesses local computer system 912 with protected data 913. Local computer system 912 is connected via network connection 915 to server computer system 916 with private data 917. Note, that in configuration 910, server computer system 915 is a “friend” of protected data 913. In data configuration 920, user 921 accesses local computer system 922 with public data 923. Local computer system 922 is connected via network connection 925 to server computer system 926 with private data 927. In data configuration 930, user 931 accesses local computer system 932 with public data 933. Local computer system 932 is connected via network connection 935 to server computer system 936 with protected data 937. The network connections used in configuration 910, 920, and 930 are preferably high speed Ethernet connections, but any suitable network connection could be used without departing from the scope of the invention.

When user 911, 921, 931 on the single local computer system 912, 922, 932 desires to run BLR 914, 924, 934 on the data located on the local computer system and the server computer system, the scenarios that occur are opposite to those that happen in configurations 810, 820, and 830. In a typical scenario, the distributed application could copy the data located on the local computer to the server computer, could copy the BLR to the server computer, and could execute the BLR on the two sets of data. A BLR could, however, be structured so that the BLR is copied to both the local computer system and the server computer system, and result information from the local computer system is only copied to the server computer system, but result information from the server computer system is never copied to the local computer system. In a more complex scenario, where a BLR produces result data of different scopes, result data could be restricted or transferred based upon the scope of the result data.

In this scenario, the ultimate result data of the BLR operating on the server computer needs to be of the same scope of the local computer system in order for the user to view the final result. Otherwise, the final result will remain on the server computer system, unless an authorization certificate is applied to the final result data.

The configuration in configuration 910 could be used where an accountant has a desktop system that contains a new type of accounting software stored on the local hard disk. The accountant also has records for one of his clients stored on the same or secondary storage medium. The accountant decides to calculate his client's taxes based on public tax tables stored on the local computer system and private salary information stored on the server computer system. The accountant launches the new type of accounting application and the software determines that the user wants to invoke the business logic to perform the calculation. The software determines that the BLR requires the tax table data which is on the local computer system as “public data,” and the salary information which is on the server computer system as “private data,” which would make the sever computer the only computer in the network capable of processing both sets of data at the same time. Next, the software checks the business logic routine's scope and determines it is authorized to transfer it down to the server computer system. It transfers the appropriate business logic routine down to the server computer system via the network, verifies that no unwanted changes were made to the code during transfer, and executes the business logic routine. The business logic reads in the data, operates on it, and produces the desired results which may be passed to the local computer system with the proper “authorization certificate” or in the event the new protected data cannot be reverse engineered.

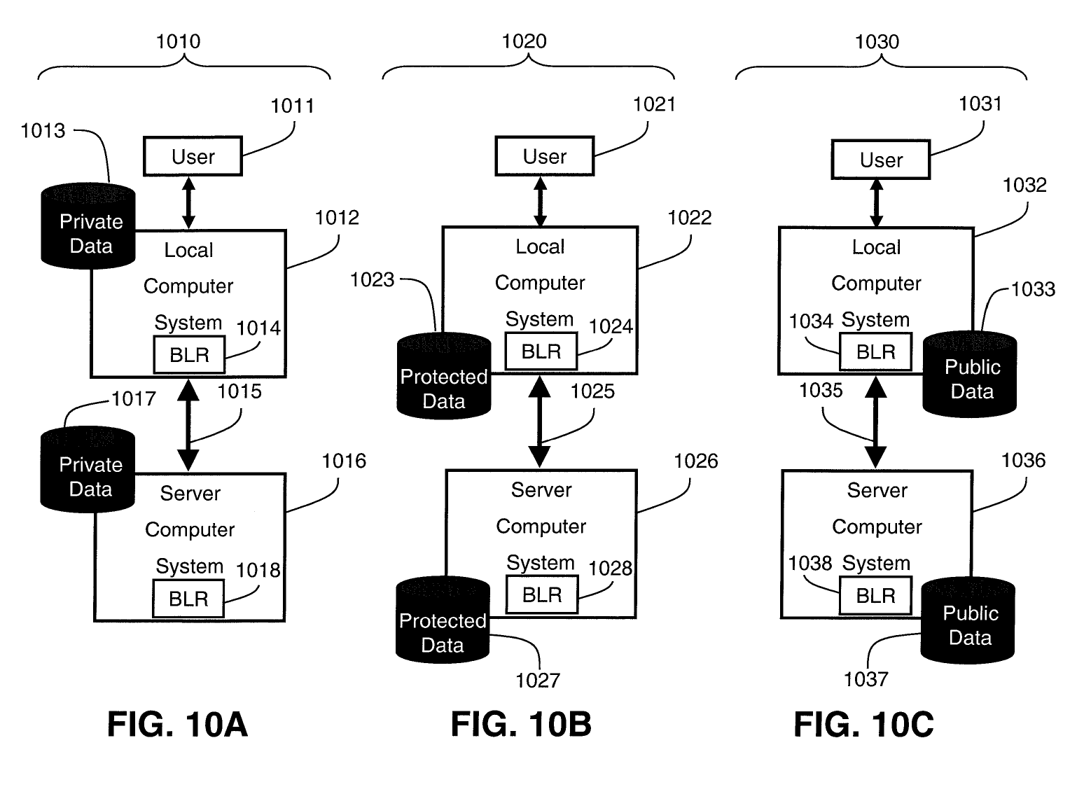

FIGS. 10A-10C show different configurations 1010, 1020, and 1030 depicted as pairs of connected computers with equal data configurations. In each data configuration, 1010, 1020, and 1030, the server computer system has the same degree of scope as the local computer system.

In data configuration 1010, user 1011 accesses local computer system 1012 with private data 1013. Local computer system 1012 is connected via network connection 1015 to server computer system 1016 with private data 1017. In data configuration 1020, user 1021 accesses local computer system 1022 with protected data 1023. Local computer system 1022 is connected via network connection 1025 to server computer system 1026 with protected data 1027. Note, that in configuration 1020, local computer system 1022 is a “friend” of protected data 1027, and server computer system 1026 is a “friend” of protected data 1023. In data configuration 1030, user 1031 accesses local computer system 1032 with public data 1033. Local computer system 1032 is connected via network connection 1035 to server computer system 1036 with public data 1037. The network connections used in configuration 1010, 1020, and 1030 are preferably high speed Ethernet connections, but any suitable network connection could be used without departing from the scope of the invention.

When user 1021 or 1031 on the single local computer system 1022, 1032 desires to run BLR 1023, 1033 on the data located on the local computer system and the server computer system, the BLRs and data can be copied to any location in an equal manner. In a preferred embodiment, the BLR is copied to both the local computer system and the server computer system, and the data is equally divided between both computer systems. The computer systems then divide up work equally in order to run the program in the most rapid manner. Of course, the BLR and the data could all be copied to one system, which runs all the calculations, if the unused computer needs to be freed for a different task, or if the BLR is one that can not be efficiently divided between multiple computers.

However, when user 1011 on the single local computer system 1012 desires to run BLR 1013 on the data located on the local computer system and the server computer system, the computation can not be done unless (1) the BLR produces public or protected result data that can be copied between computers, or (2) one computer issues an authorization certificate to the other computer to override the security settings. Two computers, both with private data, generally can not run a single BLR on both sets of data otherwise.

The configuration in configuration 1020 could be used where an accountant has a desktop system that contains a new type of accounting software stored on the local hard disk. The accountant also has records for one of his clients stored on the same or secondary storage medium. The accountant decides to calculate his client's payroll based on protected timesheets stored on the local computer system and protected salary information stored on the server computer system. The accountant launches the new type of accounting application and the software determines that the user wants to invoke the business logic to perform the calculation. The software determines that the BLR requires the timesheet data which is on local computer system as “protected data” and the salary information which is on server computer system as “protected data.” The software also determines that the local computer system is a “friend” of the salary information on the server computer, and that the server computer is a “friend” of the timesheet data on the local computer, which means that either computer can run the calculations or they can fully cooperate with one another without any worry of leaking data to an unauthorized computer. Next, the software checks the business logic routine's scope and determines it is authorized to execute it on either computer system. It makes a decision which system to make the execution system and transfers the appropriate business logic routine down to that computer system via the network, verifies that no unwanted changes were made to the code during transfer, and executes the business logic routine. The business logic reads in the data, operates on it, and produces the desired results which may be passed to the local computer system with the proper “authorization certificate” or in the event the new protected data cannon be reverse engineered.

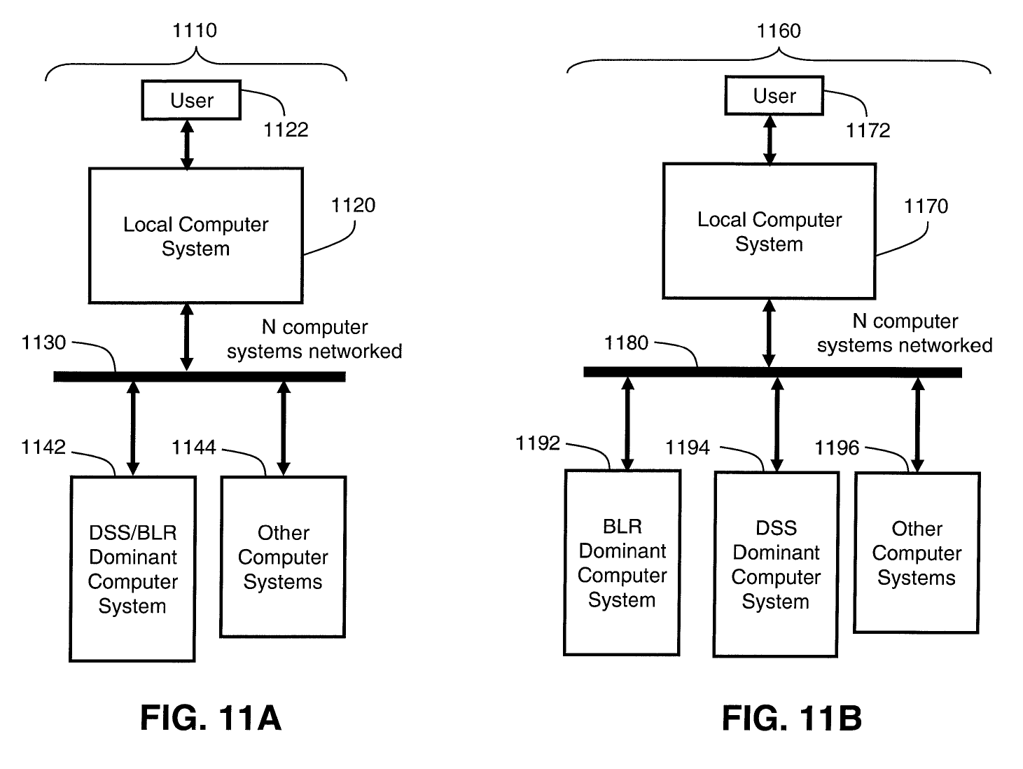

FIGS. 11A-11B show different configurations where three or more computer systems are connected through networks to run a distributed application. FIG. 11A shows a configuration 1110 where a single DSS/BLR dominant computer system 1142 is the dominant computer system for the entire distributed application, and FIG. 11B shows a configuration 1160 where one BLR dominant computer system 1192 is the dominant computer to manage all of the BLRs, and another DSS dominant computer system 1194 is the dominant computer to manage all of the data (not including BLRs) in the distributed application. In both configurations, other systems, including the local computer system accessed by the user, exist on the network to contribute data, routines, and display capabilities while the distributed application is running. The dominant computer systems are typically determined based upon their degree of scope, but could also be determined based upon hardware capabilities and connection infrastructure of the network. The dominant computer systems also preferably have authorization certificates for all computer systems to access private and protected data, but a highly secure configuration doesn't use any authorization certificates and instead relies on a well-organized infrastructure. The key point is there should always exist at least one system that is BLR dominant and at least one system that is DSS dominant, and that a single computer could be both BLR dominant and DSS dominant.

In some configurations, multiple DSS DM systems and multiple BLR DM systems could be created. While distributed applications typically have a single management system that controls the entire system from a single console, redundancy could be easily built in to have several management administrative consoles. Preferably, the management consoles are installed where the DSS DM or the BLR DM systems are located.

When a user on a local computer system desires to run BLR stored on a computer system somewhere in the network on data that is stored somewhere in the network, the distributed application determines which computers are the BLR DM systems and which computers are the DSS DM systems. The distributed application would then assign one or more computers, preferably a computer that is both a DSS and a BLR DM system, as the management system to control execution of the distributed application. The system could arrange for all of the BLRs and data to be transferred to the management system to execute the BLRs on the data on that execution system, but would more typically distribute the load in order to optimize the runtime. When all of the data is copied to one single execution system, authorization certificates would typically need to be distributed, particularly when the data is private.

When multiple BLRs are run serially and/or concurrently, multiple “control areas” may be created, each one with its own scope of data. Typically when groups of computer systems share a protected class of data, all of the “friends” of a type of protected data are grouped in a single control area for the duration of the computation.

The configuration in FIG. 11A or 11B could be used where an accountant working in a large firm with many desktop and server systems desires to run a new type of accounting software stored somewhere on the network storage. The accountant decides to calculate his client's taxes based on public tax tables, protected timesheet data, and private salary information all stored various but different places somewhere on the network. The accountant launches the new type of accounting application and the software determines that the user wants to invoke the business logic to perform the calculation. The software then determines that the BLR is computer system dominant on servers “A”, “B”, and “D”. The software also determines that the BLR requires the tax table data which is “Public Data” on “Server B”, timesheet information which is “Protected Data” on “Server C”, and the salary information which is “Private Data” on “Server D” to execute the logic successfully. Based on the rules previously described and the table above, the software determines that the DSS DM is “Server D” with a private degree of scope and based on the previously derived BLR DM that the Execution System must be “Server D”. The software transfers the appropriate business logic routine down to “Server D” via the network either on demand or previously, verifies no unwanted changes were made to the code during transfer, and executes the business logic routine. The business logic reads in the data, operates on it, and produces the desired results which may be passed to the local computer system with the proper “authorization certificate” or in the event the new protected data cannon be reverse engineered.

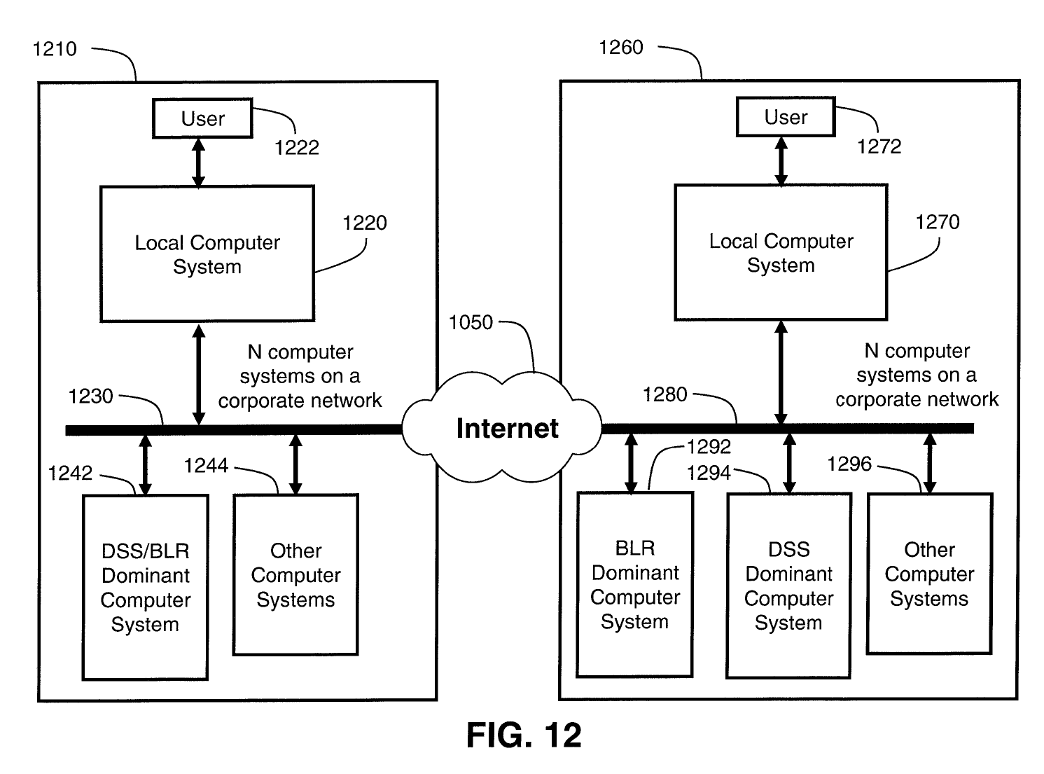

FIG. 12 shows two intranet networks of N computers 1210 and 1260 that are connected to one another via the Internet 1050, which then forms one large interconnected network for a distributed application. As with the networks in FIGS. 11A and 11B, the networks 1210 and 1260 have DSS DM and BLR DM systems located throughout the extended network, respectively. While networks 1210 and 1260 are shown to be intranet networks, networks 1210 and 1260 could be other kinds of networks without departing from the scope of the invention. Contemplated networks include, but are not limited to, a local area network, wide area network, wireless local area network, metropolitan area network, server area network, campus area network, personal area network, or desk area network. Networks 1210 and 1260 also do not have to be the same kind of network, but can be two very dissimilar networks connected using a network connection. Likewise, while networks 1210 and 1260 are shown to be connected using the Internet 1050, networks can be connected using a multitude of other connective techniques and technologies without departing from the scope of the invention.

Here, the computer systems and operational behavior works the same as in FIGS. 11A and 11B. The single DSS/BLR system 1242 could control the entire distributed application on both networks, or preferably each network 1210 and 1260 has its own separate BLR DM and DSS DM that helps coordinate the efforts of each network, and is used as a communication rally point for information to be transmitted between the networks. Typically, when each network is on an intranet subnet, the BLR and data located on the intranet has a designated protected scope, with each of the computer systems within the network designated as “friends” of the data and BLR. However, every computer in each network could also be in a DMZ and freely able to communicate with any other computer. While only two networks are shown in FIG. 12, many more networks could be connected to one another in the distributed application without departing from the scope of the invention.

The configuration in FIG. 12 could be used where a user 1222 wishes to run an application on private data stored on his local computer system 1220, protected data within his corporate intranet 1210, and public data on a company that provides the distributed application 1260. DSS/BLR DM system 1242 sends a request to copy BLR routines from intranet 1260 to intranet 1210 to run on all the computer systems in intranet 1210, and then orders other computer systems 1244 to run BLR algorithms on protected data. Those results are then fed to local computer system 1220, which then runs a BLR algorithm on the aggregated results of data from the other computer systems, and merges that data with the private data on the local computer system 1220, which then outputs the result to user 1222.

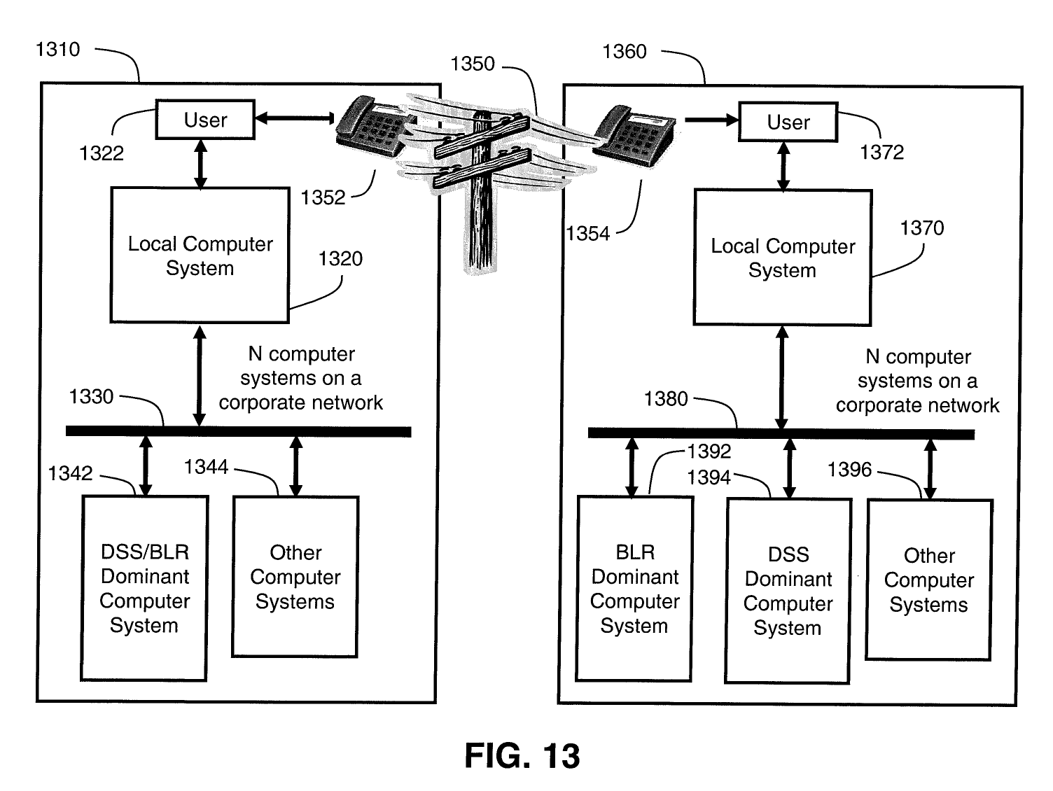

FIG. 13 shows two unconnected intranet networks 1310 and 1360, where each user 1322 and 1372 utilizes telephones 1352 and 1354 to speak to one another over telephone network 1350. Neither independent network is directly connected to one another, but in all other aspects intranet 1310 and 1360 are similar to intranet 1210 and 1260, respectively.

The configuration shown in FIG. 13 could be used where two agents 1322 and 1372 are working on similar projects for two companies that are competitors with one another. Since both companies have identical environments, they each have copies of all the data and business logic but for security purposes the two networks are not connected to one another. One agent from company 1310 calls an agent from company 1360 to discuss some test data run independently on each site. The two agents both start up a distributed program in their respective networks to perform calculations on data also stored in their respective, unconnected networks. The agents are provided with results, and can compare results, or can tell one another different data to put in each other's computer system to synchronize results in a profitable way. Each agent is able to discuss the data with one another using the secure telephone connection 1350.

Again, the results could be chained creating an entire system of functionality based on the model described herein.

Exemplary uses of the inventive subject matter are discussed below in order to highlight advantages of the invention.

E-Mail Example

An unknown sender sends an email from their personal computer through their email server to a user's email server. The user connects to his email server from his laptop computer and sees that a new email has an attachment that is ready to read, but the user doesn't recognize the sender. The user, being a suspicious person, chooses to assign the attachment a data scope of PRIVATE to the sender. Based on the inventive technology, the execution would occur on the sender's computer and the output would be displayed on the user's laptop providing a significant level of protection to the user. In the event the attachment contained a virus, the harmful effects of the virus would only cause harm to the sender's computer system, and not the user's. This is also an example of a scope-aware email application.

Storage Device Example

A user develops a new type of storage device that implements scope-aware logic. A system administrator installs a new application into the environment which writes it to the storage device. At the same time, the system administrator dictates that the application is PRIVATE data because of the proprietary nature of the algorithms it uses. The storage device now knows it cannot transfer the programs off the storage device without some authorization certificate. The user attempts to run the program without an execution certificate and the scope-aware storage unit rejects the request. The user then obtains the appropriate certificate and attempts to execute the software application a second time. This time, the scope-aware storage unit allows the user to execute the application. The application requests access to a variety of data as part of its normal processing and the scope-aware storage unit evaluates the scope assigned to each piece of data, along with the authorization certificates, to determine which computer systems it can transfer the data to. All this logic is all built into the new scope-aware storage system.

Software Platform Example

A user develops a new type of software platform that implements scope-aware logic. A system administrator installs a new application into the environment which registers with the overarching software platform. The software platform now provides functionality to the individual application to manage its scope-aware capabilities. Each time the user attempts to execute an application, the platform checks the application's degree of scope and the user's authorization certificates. Once the application begins operating, the application outputs all data requests through the platform APA user which controls access to data based on the data's degree of scope and authorization certificates based on the rules previously described herein.

Hardware Example

A user develops a new hardware platform that implements scope-aware logic. The address controllers that provide the operating system with access to physical memory, cache, or disk could be built with scope-aware logic that prevents a particular user from even seeing that memory exists, when it contains private data. Trace lines would carry information about the user to the new address controller chip that would determine whether the user has access to the specified information based on the data's degree of scope and the user's authorization certificate. In the event they did not have appropriate access, the operating system would be provided with information from another cell that contains no information. In this way, programs could be prevented from crossing logical boundaries to gain access to physical assets.

Network Example

A user develops a new network protocol that implements scope-aware logic. The actual signal amplitudes or phases are changed to incorporate scope-aware information into the low-level transport protocol. This information would include the data's degree of scope, owner (user), authorization certificate information, etc. which is carried along with the data. The devices that interpret the actual signal would understand this scope-aware information and pass it along through the hardware to the computer system's hardware which in turn would use it as described in the hardware platform example above or pass it on to the software platform for use as described above. It should be noted that the designers could choose to implement the logic at any of the seven layers in the ISO network model.

Thus, specific compositions and methods of securing data used in a distributed application have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method of securing data to be processed by a distributed application, comprising:
deploying a distributed application on a first computer system with a first subset of the data, and on a second computer system with a second subset of the data;
defining a security policy that restricts the distributed application from transferring the first subset of the data from the first computer system to the second computer system;
using the distributed application to concurrently transform the first and the second subset of the data into a first processed data and a second processed data, respectively; and
transmitting the first processed data to an output device logically addressable by the first computer system.

2. The method of claim 1, wherein a portion of the distributed application runs on a third computer system, different from the first and second computer systems, and wherein the security policy allows the distributed application to transfer the first subset of the data from the first computer system to the third computer system.

3. The method of claim 2, further comprising using the distributed application to load balance the first set of the data among the first computer system and the third computer system.

4. The method of claim 2, wherein the first computer system and the third computer system share a common storage area.

5. The method of claim 2, wherein the first computer system and the third computer system are on a common intranet.

6. The method of claim 2, wherein the first subset of the data is a business logic routine of the distributed application.

7. The method of claim 1, wherein the security policy allows the distributed application to transfer the second subset of the data from the first computer system to any other computer system that concurrently runs the distributed application with respect to the data, including the first computer system.

8. The method of claim 1, wherein the security policy restricts the distributed application from transferring the first subset of the data from the first computer system to any other computer system that concurrently runs the distributed application.

9. The method of claim 1, wherein the output device attached to the first computer system is a computer screen.

10. The method of claim 1, wherein the output device attached to the first computer system is at least one of the second computer system and a third computer system, wherein a portion of the distributed application runs on the third computer system, different from the first and second computer systems.

11. The method of claim 1, wherein the security policy restricts the distributed application from transferring the first processed data from the first computer system to the second computer system.

12. A system for processing data securely in a distributed application environment, comprising:
a plurality of networked computer systems;
a distributed application configured to cooperatively run on the plurality of networked computer systems to process the data; and
a security module that allows only a first subset of the plurality of computer systems to access a first subset of the data.

13. The system of claim 12, further comprising a user interface logically coupled to the security module, and configured to enable a user to assign the first subset of the plurality of computer systems to the first subset of the data.

14. The system of claim 12, wherein the first computer system and the second computer system are functionally networked to one another via the Internet.

15. The system of claim 12, wherein the first subset of the plurality of computer systems share an intranet connection.

16. The system of claim 12, wherein the security module allows a second subset of the plurality of computer systems to access a second subset of the data that is non-overlapping with the first subset of the data.
